(19) United States
(12) Patent Application Publication
(10) Pub. No.: US 2010/0171043 A1
(43) Pub. Date: Jul. 8, 2010

(54) SINGLE ELEMENT SENSOR WITH MULTIPLE OUTPUTS

(75) Inventors: Conor Burke, Laytown (IE); John Moore, Swinford (IE)

Correspondence Address: SEED INTELLECTUAL PROPERTY LAW GROUP PLLC, 701 FIFTH AVE, SUITE 5400, SEATTLE, WA, 98104, US

(73) Assignee: DUBLIN CITY UNIVERSITY, Dublin (IE)

(21) Appl. No.: 12/663,255

(22) PCT Filed: May 29, 2008
(86) PCT No.: PCT/EP2008/056643

§ 371 Date: Dec. 4, 2009

Related U.S. Application Data
(60) Provisional application No. 60/942,271, filed on Jun. 6, 2007.

(51) Int. Cl. G01N 21/64

(52) U.S. Cl. 250/459.1; 250/458.1

(57) ABSTRACT

An analyte sensor is described. The sensor employs a single sensor element which provides a plurality of phase outputs in response to excitation by a modulated excitation source. The plurality of phase outputs may be analysed to provide information on the presence of one or more analytes.

### BACKGROUND

1. Technical Field

The present disclosure generally relates to the field of sensors and particularly to sensors having a sensor element which is responsive to excitation by an excitation source to generate a plurality of phase response outputs, analysis of the outputs providing information on one or more analytes. In a preferred arrangement the invention relates to luminescence-based optical sensors, and more particularly, to sensors based on a technique that exploits the cross-sensitivity of luminescence sensors that are based on phase detection methods in order to extract quantitative information on multiple analytes from the response of a single sensing element.

2. Description of the Related Art

Sensors are well known and used for detecting any number of different analytes. Unfortunately it is known that a sensor that is provided for sensing a particular analyte may have response characteristics dependent on parameters other than the concentration of the analyte desiring sensing. In such arrangements it is known to provide a sensor having two or more different sensor elements, each providing an output based on a different parameter and then using the different outputs to cross calibrate.

An example of such sensor applications is oxygen sensing. Oxygen sensing is widely used across a broad range of industrial applications in various fields such as biomedical, environmental and food packaging. It is well established that optical oxygen sensors and, in particular, phase fluorometric oxygen sensors, offer significant advantages in this regard.

Unfortunately, a key problem for such sensors is their cross-sensitivity to temperature. Thus, it is necessary to perform a rigorous temperature calibration of the sensor in order to ensure its reliable performance. Such a calibration is typically achieved by recording the sensor response across a range of temperatures, while measuring temperature simultaneously with an independent temperature sensor such as a thermocouple, thermistor or thermopile. This impairs the accuracy of the sensor, which is typically based on a luminescent complex that has been encapsulated in a solid matrix, due to the fact that the independent temperature sensor does not measure the temperature of the sensor matrix but instead measures that of the surrounding environment. Such independent sensors invariably possess a different response time to temperature than that of the sensor matrix, with the result that it is not possible to accurately compensate in real time for the effect of temperature changes on the optical sensor response.

Attempts have been made by others to accurately measure the temperature of the sensor matrix through the co-immobilization of a temperature-sensitive (yet analyte-insensitive) luminophore with the analyte-sensitive luminophore and monitoring the luminescence outputs of both. This requires careful selection of optical filters and/or additional excitation sources. If a single source is to be used, a great deal of effort must be applied to the synthesis of spectrally compatible luminophores. The sensor matrix preparation protocol may also require significant modification to facilitate the incorporation of the additional luminophore. The simultaneous detection of two analytes through the use of two modulation frequencies has been described, however, it is stipulated that two luminophores are required to achieve the detection of two analytes. Furthermore, those techniques were limited specifically to the detection of two analytes using Dual Luminophore Referencing (DLR).

There is therefore a need for an improved sensor and also for improved sensing techniques.

### SUMMARY

These and other problems are addressed by a sensor which in accordance with the teaching of the invention provides a sensor element having a multi-phase response to excitation that can be analysed to provide information on the presence of one or more analytes.

Such a sensor system may typically comprise an excitation source, a sensor element having a response output proportional to the presence of one or more ambient analytes, and a detector module. By providing the sensor element responsive to excitation by the excitation source so as to generate a plurality of phase response outputs, it is possible for the detector module to be configured to operably analyse the phase response outputs to provide information on the one or more ambient analytes. The excitation source desirably provides a modulated output and the sensor element provides a response related to that modulated output. Typically the sensor element is a luminescence based sensor element which is responsive to incident light generated by the excitation source. The excitation source may provided a frequency modulated output providing a plurality of frequencies. The sensor element generates a plurality of phase outputs, each of the phase outputs generated being related to the frequencies generated by the excitation source but phase shifted relative thereto.

The present inventors have realized that the degree of phase shifting effected by the sensor element is related to the specifics of the sensor element and its sensitivity to particular analytes within the ambient environment. Using these phase shifted outputs it is possible for the detector module to provide information related to the specifics of the one or more analytes within the environment. Such analysis may be conducted using multidimensional data analysis techniques such as those which include a comparison of one phase response output with that of another such as may be provided by successive approximation techniques. Another analysis methodology that may be employed would use artificial neural networks or the like to identify features in the phase response outputs as being indicative of the presence of one or more predetermined analytes. In such a latter arrangement the plurality of phase response outputs are desirably combined into a set or pattern and the pattern is examined as a whole for features that would indicate the presence of one or more analytes.

The sensor element is desirably luminescent based. Such a sensor element may include one or more luminophores, the term being used in its generic form and intending to include both fluorphores and phosphors. Using such luminophores, the present invention provides a sensor that may operably implement a technique that facilitates the exploitation of sensor cross-sensitivity in order to extract multianalyte information from a single sensor element that employs only one luminophore. In accordance with the teaching of the invention a technique is provided that facilitates the real-time, simultaneous monitoring of for example temperature and the analyte concentration of interest without the need for an independent temperature sensor or an additional, temperature-sensitive luminophore.

These and other features of the present invention will be better understood with reference to the following exemplary embodiments which are provided to assist in an understanding of the teaching of the invention.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 is a chart showing sensor calibration curves recorded for a variety of modulation frequencies;

FIG. 2(a) is a chart showing 3D calibration surface obtained for MTEOS derived optical oxygen sensors;

FIG. 2(b) is a chart showing 3D calibration surface obtained for PTEOS derived optical oxygen sensors;

FIG. 3 is a chart showing the comparison of uncompensated and temperature compensated sensor responses.

### DETAILED DESCRIPTION OF EXEMPLARY EMBODIMENTS

A sensor provided in accordance with the teaching of the present invention includes a sensor element having multi-phase response to excitation that can be analysed to provide information on the presence of one or more analytes. Within this context excitation of the sensor may provide two or more phase responses from the sensor element. In accordance with the teaching of the invention, a sensed analyte will have different response characteristics in different phase response outputs from the sensor element and this can be used to characterize the analyte or indeed to discriminate between two or more analytes.

To assist with an understanding of this teaching of the invention an exemplary arrangement providing an optical oxygen sensor with intrinsic temperature compensation will now be described. Such a sensor implements a technique that requires only a single, unmodified sensor element and a single excitation source and thus can be extended to the simultaneous detection of multiple interfering species, e.g., humidity, pH, using a single sensor. The present inventors have found that luminophores—that class of material that have the capability to manifest luminescence—are particularly useful as sensor elements in that they are responsive to excitation to provide an optical output which is detectable by a detector. This exemplary technique is based on the generation of two different sensor calibration equations from a single sensor in order to produce a system of two equations in two unknowns such as temperature and oxygen. The equations can then be solved as a set of simultaneous equations using a numerical technique known as successive approximation in order to yield values for temperature and oxygen concentration. This technique exploits the successive approximation method but involves the use of a single sensor element from which two distinct sensitivities to the analyte of interest, e.g., oxygen, can be extracted through the simultaneous application of two modulation frequencies to the optical excitation source such as an LED.

If using a luminophore, the similarly modulated luminescence emission can then be detected using a single photodetector and the two frequency components analyzed separately using custom-designed, digital signal processing (DSP) based electronics. This facilitates the simultaneous generation of two sensor calibration functions, which can be solved to yield values for the two analytes of interest, in this exemplary embodiment, oxygen and temperature. As implemented in this arrangement, this technique is ideally suited to the simultaneous detection of oxygen and temperature using phase fluorometry, as the sensor response is inherently linked to the modulation frequency of the excitation source, i.e. different sensitivities can be achieved by using different modulation frequencies. Through the use of additional excitation frequencies, this technique could facilitate the simultaneous detection of oxygen, temperature, humidity, pH along with a variety of different gases or chemicals. For example, O₂, CO₂, chlorine, ammonia, volatile amines, nitrates, calcium, and metal ions or any subset thereof, etc. can potentially be detected. The technique can be extended to any number of analytes to which sensors display cross-sensitivity or to any detection technique where the sensitivity of the sensor is dependent upon the modulation frequency of the excitation source, e.g., carbon dioxide or chlorine sensors based on Dual Luminophore Referencing.

To determine more than one parameter, different modulation frequencies should be applied to the excitation source. These different frequencies could be provided by varying the current applied to an excitation source such as a light emitting diode (LED) which is used to induce excitation in a provided luminophore. The light output in response from the provided luminophore will be phase shifted relative to the excitation source, the degree of shifting being related to the presence or otherwise of one or more analytes. A frequency-dependent sensitivity is described by the following equation:

tan φ=2πfτ

Where, φ is the detected phase angle, f is the modulation frequency and τ is the luminescence lifetime of the excited luminophore.

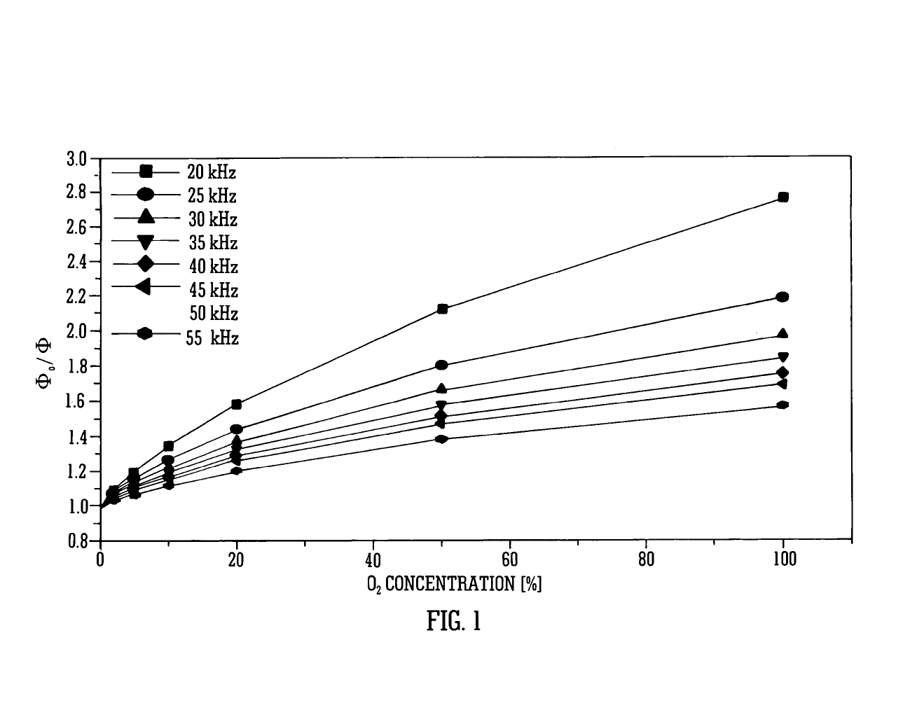

FIG. 1, for example, shows sensor calibration curves recorded for a variety of modulation frequencies. This exemplary arrangement is based on a sol-gel-based sensor as was derived from the precursor MTEOS (methyltriethoxysilane) and doped with the fluorescent compound, ruthenium (II)-tris-(4,7-diphenyl-1,10-phenanthroline) dichloride (Ru(dpp)3Cl2). These data show that the sensor calibration curve varies with the modulation frequency employed, thereby demonstrating the feasibility of generating more than one calibration equation from a single sensor element.

It will be appreciated that this specific set of compounds are exemplary of the type of configurations that may be usefully employed within the context of the teaching of the invention. Depending on the nature of the analyte for which the sensor is designed different luminophores could be used as specific sensor elements.

For example, the following is a non-exhaustive list of luminophore families that are compatible with phase fluorometric measurements and could therefore be considered for use as sensor elements within a sensor provided in accordance with the teaching of the present invention.
1. Luminescent platinum group metal complexes with α-diimine ligands
   a. Ruthenium (II) diimine complexes, e.g., ruthenium(II) tris(2,2′-bipyridyl); ruthenium(II) tris(1,10-phenanthroline); and ruthenium(II) tris(4,7-diphenyl-1,10-phenantroline),
2. Platinum (II) porphyrins, e.g., platinum(II) octaethylporphyrin; platinum(II) tetrakis-(pentafluorophenyl)porphyrin.
3. Palladium (II) porphyrins, e.g., palladium(II) octaethylporphyrin.
4. Cyclometalated iridium (III) coumarin complexes
5. Luminescent lanthanide complexes
   a. Europium (III) complexes
   b. Terbium (III) complexes

The detection of pH in addition to analytes such as carbon dioxide and ammonia may be achieved using pH indicators that are fluorescent or colorimetric (i.e., colour changing). These may be co-encapsulated with phase fluorometry-compatible complexes such as those mentioned above and could, therefore, also be considered useful within the context of a sensor provided in accordance with the teaching of the present invention.

Examples of fluorescent pH indicators that could be used include:
1. Fluorescein and its derivatives including amino fluorescein, SNARF-1 (Seminaphtharhodafluor), and SNAFL (seminaphtho fluorescein).
2. Hydroxypyrene trisulfonic acid (HPTS)
3. Coumarin-based indicators

Examples of colorimetric pH indicators that could be used include:
1. The sulfonephthalein dye family, including bromocresol purple, bromocresol green, cresol red, and bromothymol blue.

While it is not intended to limit the present invention to any one specific combination of features or elements it will be understood that certain complexes may be found more useful for different analytes. For example, carbon monoxide may be detected using colorimetric metal phthalocyanine (Pc) complexes. Where these or similar complexes are utilized it may be necessary to provide the sensor element as a co-encapsulation of the colorimetric complexes with a suitable phase fluorometry-compatible fluorescent indicator in order to exploit a multifrequency/multiphase-based system such as that provided in accordance with the teaching of the invention. Examples of such Pc complexes include: cobalt phthalocyanine, copper Pc, iron Pc, nickel Pc, and zinc Pc.

In contrast, nitric oxide may be detected using a colorimetric heme protein (co-encapsulation again may be required as was outlined above).

Nitric oxide and nitrite may also be detected fluorometrically using 4,5-diaminofluorescein diacetate.

Humidity may be detected colorimetrically using cobalt chloride and fluorometrically using the ruthenium complex, ruthenium(II)diphenylphenanthroline-dipyridophenazinehexafluorophosphate.

Chloride may be detected fluorometrically using lucigenin and co-encapsulation would again be required. Ca²⁻ may be detected fluorometrically using Calcium Green and its derivatives in addition to Fura-2, Indo-1, Fluo-3, Fluo-4, Rhod-2, Oregon Green and related derivatives. Mg²⁺ may be detected fluorometrically using Mag-Fura-2, Mag-Fura-5, Mag-Indo-1, Mag-Fluo-4 and Magnesium Green. Na⁺ and K⁺ may be detected using SBFI and PBFI, respectively.

Phosphate may be Detected Using MDCC-PBP.

A broad range of metal ions may be detected fluorometrically, for example Phen Green FL and Phen Grenn SK may be used to detect Fe²⁺, Fe³⁺, Cu²⁺, Cu⁺, Hg²⁺, Pb²⁺, Cd²⁺, and Ni²⁺. Calcein may be used to detect Co²⁺, Ni²⁺, Cu²⁺, Al³⁺Fe²⁺and Fe³⁺. Fura-2 may be used to detect Cd²⁻, while Newport Green indicators may be used to detect Ni²⁺, Zn²⁺, and Co²⁺.

It will be understood that the above is a non-exhaustive listing of the type of analysis that may be conducted by matching the response behavior of the sensor element to the desired analyte.

Irrespective of the nature of the material providing the multi-phase output, a detector module provided in accordance with the teaching of the invention is desirably capable of simultaneous detection of two or more phase outputs. In a preferred arrangement the detector module may be provided as part of a control system for the sensor, the control system also providing a control signal to the generator for the excitation source so as to induce an output from the excitation source of two or more modulation frequencies. Using such a detector, the simultaneous generation and detection of two or more modulation frequencies in a fluorescence emission signal can be accomplished using a processor/micro-controller in conjunction with a digital to analog converter (DAC) and an analog to digital converter (ADC) to modulate the excitation source and sample the resulting fluorescence signal. The sampled data can then be processed in real-time by the processor using the synchronous demodulation technique to calculate the phase difference between the excitation signal and the fluorescence signal. As the processor/DAC is capable of generating any arbitrary waveform, it is possible to modulate the excitation source at any number of frequencies simultaneously. The resulting phase shift at each constituent frequency can be determined simultaneously by carrying out synchronous demodulation at each of the relevant frequencies, thereby generating a sensor response at each frequency. A variety of conventional, commercially available instrumentation can be used for the excitation and detection of the fluorescence emission signals.

Once the fluorescence emission signals are detected the individual phase outputs can be analysed. Such analysis may utilize a comparison of the outputs. To this end equations describing the different calibration curves may be generated and solved by treating them as a set of simultaneous equations, thereby extracting quantitative information on the analytes of interest from the different calibration curves. Such equations may be solved analytically for linear calibrations but, in the case of non-linear calibration surfaces, which is commonly the case for the oxygen sensors, a successive approximation technique may be used. An alternative technique that could be used is use of artificial neural networks which could be configured to analyse each of the outputs individually and then to provide an output response based on this analysis. It will be appreciated that both these described examples are exemplary of a multi-dimensional analysis technique that may be usefully employed within the context of the teaching of the present invention.

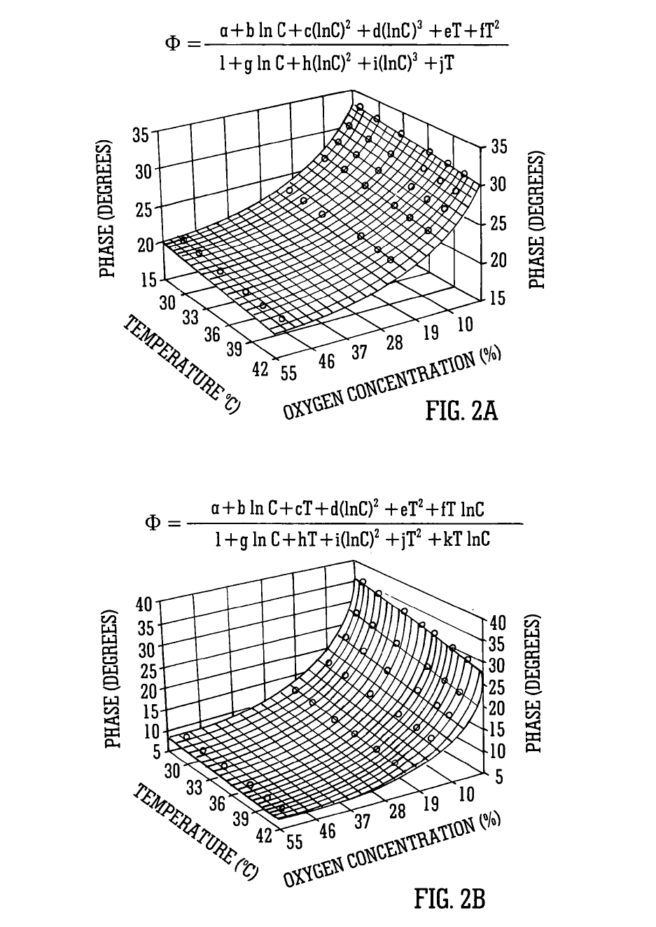

An example of an analytic capability is demonstrated in FIGS. 2(a) and 2(b) for the case of simultaneous oxygen and temperature detection using two sensor elements.

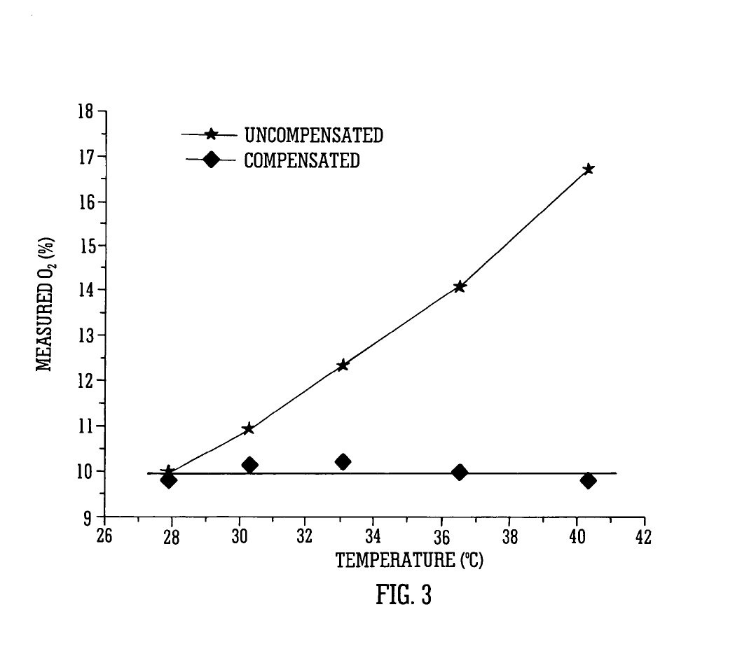

FIGS. 2(a) and (b) are 3D calibration surfaces obtained for (a) MTEOS- and (b)PTEOS (propyltriethoxysilane)-derived optical oxygen sensors that have been generated for each of the two sensor elements by simultaneously exposing them to an environment where both temperature and oxygen concentration were precisely controlled and recording the sensor response for a variety of preset oxygen concentrations and temperatures. The successive approximation technique was then used to solve the set of two simultaneous equations describing these surfaces (equations displayed above FIGS. 2(a) and 2(b)) and thereby calculate oxygen concentration and temperature from the two phase angles (one for each sensor element) that were returned for any measurement. As a consequence, real-time temperature measurement and compensation was possible. This is illustrated in FIG. 3, where curve A describes the response of one of the oxygen sensors at a fixed oxygen concentration over a range of increasing temperatures, while curve B displays the temperature-compensated response of the same sensor. These data show the ability to solve the equations describing the different calibration curves by treating them as a set of simultaneous equations, thereby extracting quantitative information on the analytes of interest from the different calibration curves.

A technique according to the present disclosure uses multi-frequency excitation and detection in conjunction with phase fluorometry and successive approximation in the production of a multianalyte optical chemical sensor. The use of such a system to exploit the cross-sensitivity of a single-element sensor in order to render it capable of multi-analyte detection is applicable in many fields. As a commercially relevant example, the technique described here makes it possible to achieve temperature compensation using a single sensor element and excitation source without the use of an independent temperature sensor. This is a significant innovation in the field of optical oxygen sensing, as it permits the user to detect and compensate for temperature changes in a contact-free manner, a characteristic that is extremely attractive for a number of oxygen sensing applications, in particular those of Modified Atmosphere Packaging (the primary application area targeted by GSS, http://www.gss.ie/) and probe-type DO sensors such as those manufactured by YSI Environmental (http://www.ysi.com/opticalDO/), PreSens Precision Sensing GmbH (http://www.presens.de/), Ocean Optics, Inc. (http://www.oceanoptics.com/products/sensorsystem.asp) and Interlab Electronic Engineering (http://www.interlab.es/). This technique could also be extended to the detection of multiple interfering analytes through the use of additional excitation frequencies. This could facilitate the simultaneous detection of oxygen, temperature, humidity and pH using a single sensor spot, assuming the sensor displayed adequate cross-sensitivity to these analytes.

It will be appreciated that what has been described herein are exemplary embodiments of an oxygen sensor implemented in accordance with the teaching of the present invention. By exciting a luminophore that is sensitive to the presence of oxygen using a multi-frequency excitation source it is possible to induce from the luminophore one phase angle output corresponding to each of the frequencies of the excitation source. These multiple phase outputs can be analysed to provide indications of the concentration of the ambient oxygen within the sensor environment.

Heretofore what has been described is the use of a single sensor element incorporating a single luminophore. It will be appreciated that depending on the desired application for the sensor that two or more luminophores could be combined together into a single sensor spot. It is important to note that for such a sensor element to function that each of the combined luminophores should be spectrally compatible with the excitation source (in the case of photoluminescence-based systems) and, in the case of DLR (Dual Lifetime Referencing; also known as Dual Luminophore Referencing) or FRET (fluorescence resonance energy transfer; also known as Förster Resonance Energy Transfer)-based applications, spectral compatibility with one or more of the co-encapsulated luminophores will be necessary. Compatibility of the luminophore with the host matrix (for example solubility within the matrix), where such a matrix is employed, is also to be considered.

It will also be noted that if the luminophore is provided in a stabilizing matrix that the choice of stabilizing matrix could be tailored for specific applications. For example, if the sensor required a hydrophobic membrane then a suitable matrix could include one of MTEOS, PTEOS and ETEOS. These membranes could also be considered suitable for specific applications such as for example reduced proton permeation, i.e., reduced pH sensitivity applications

It is also possible within the context of the teaching of the present invention to provide two or more of the same luminophore in a single sensor element but to provide one of the two in a different encapsulate than that of the others to engineer a different response characteristic. Examples of an encapsulate that could be used include nanoparticles or indeed the employment of multiple sol-gel/polymer thin films combined in a single spot to achieve this effect of differentiated response.

It will be appreciated that where the detection module makes use of a successive approximation technique (or similar mathematical analysis techniques), it is necessary for the detector to be able to distinguish between the different phase outputs. One limitation in this resolution capable is dictated by the noise in the recorded signal. In order for the system of simultaneous equations to be solved, the sensor sensitivities at each excitation frequency typically should differ sufficiently from one another. The signal noise itself defines minimum and maximum slopes around the sensor response slope (which defines sensitivity). The difference in sensitivity, ΔS must be larger than the difference between the minimum and maximum slopes, Δm defined by the sensor noise. It will be appreciated and understood that the specifics of the make-up of the achievable resolution will depend on the measurement environment and the sensor used It will be appreciated that while sensitivity is important in many sensor applications one application of particular relevance within the context of the teaching of the present invention is that of breath monitoring. In breath, many of the relevant gas concentrations are in the single and sub-ppb ranges and these ranges must, therefore, be accessible/measurable by the sensor. Analytes of interest include carbon monoxide, nitric oxide, acetone, acetaldehyde, formaldehyde, isoprene, isopropanol, hydrogen peroxide, and methanol—this list being as will be appreciated not an exhaustive list. The use of array-based sensors coupled with artificial neural networks has been shown by others to improve detection limits by a factor of 5-10 and using the teaching of the present invention such sensitivity could also be employed using a single sensor element to provide the necessary information. It will be further appreciated that a system according to the teaching has heretofore been described with reference to exemplary arrangements employing phase fluorometry and DLR. Systems provided in accordance with the teaching of the invention could also be modified to take advantage of FRET. In implementation of a system based on such FRET techniques it will be understood that would not require different system components, merely co-encapsulation of a luminescent dye with either a colorimetric dye or a second luminescent dye. FRET is an approach that enables the use of colorimetric indicators in lifetime- or phase fluorometry-based sensors by converting the colour change into lifetime information. The indicator must be co-encapsulated with a luminescent complex that has an emission spectrum that overlaps with the absorption spectrum of the colorimetric indicator. The excitation source is used to excite the luminophore (referred to as the donor), which transfers its energy in a radiationless manner to the colorimetric indicator (referred to as the acceptor), resulting in the modulation of the intensity and decay time of the luminophore. FRET may equally be employed in a system comprising two luminophores, one acting as the donor instead of a colorimetric indicator. In such a system, the donor absorbs the excitation radiation and, instead of luminescing, transfers its energy in a radiationless manner to the acceptor, which then luminesces. It will be appreciated that the sensor and methodology herein described is particularly suited to taking advantage of such techniques.

It will be understood that while the application of the teaching of the present invention is not intended to be limited to any one set of components or integers an exemplary arrangement will now be described. In this arrangement the excitation source is provided a a light source in the form of a 5 mm blue LED having a 450 nm maximum output wavelength as supplied by Roithner LaserTechnik, Austria. The detector module includes a Si PIN photodiode detector as provided under part number S1223-01 by Hamamatsu Photonics UK. Excitation (Excitation filter—blue bandpass, Semrock (FF01-447-60) and emission (Emission filter—550 nm longpass filter, Thorlabs) filters are also provided, with the excitation filters provided between the excitation source and the sensor element and the emission filter between the sensor element and the detector. Use of these filters advantageously address the issue of spectral crosstalk and the associated increase in background signal, which may adversely affects sensor performance. As was discussed above, a processor component of the detection module may include a DAC capable of generating any arbitrary waveform and it is thus possible to modulate the LED at any number of frequencies simultaneously. The resulting phase shift at each constituent frequency can be determined simultaneously by analyzing the output of the photodiode by carrying out synchronous demodulation at each of the relevant frequencies, thereby generating a sensor response at each frequency.

It will be appreciated that exemplary arrangements of an analyte sensor have been described herein. The sensor employs a single sensor element which provides a plurality of phase outputs in response to excitation by a modulated excitation source. Within the context of the present invention the term “single” when used with reference to the sensor element is intended to define an element that is individual and distinct. Each element may comprise one or more luminophores but a single sensor element may be employed to provide a plurality of phase outputs. The plurality of phase outputs may be analysed to provide information on the presence of one or more analytes. While preferred arrangements, components and applications have been described it is not intended to limit the scope of the present teachings to those exemplary arrangements as modifications can be made without departing from the teaching. It will be appreciated that while a sensor system may usefully employ a single sensor element and use that single sensor element to provide a plurality of outputs, other arrangements may include an array of such sensor elements. In such an arrangement individual ones of the sensor element will each provide a multi-phase output.

The words comprises/comprising when used in this specification are to specify the presence of stated features, integers, steps or components but does not preclude the presence or addition of one or more other features, integers, steps, components or groups thereof.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

1. A sensor system for detecting the presence of two or more analytes, the system comprising:
an excitation light source operable to simultaneous provide a modulated multi-frequency output,
a single-element sensor which includes an individual luminophore configured for extracting multianalyte information,
the individual luminophore being responsive to excitation by the excitation light source to generate two or more phase response outputs, and
a detector module configured for simultaneous detection of the two or more phase outputs from the individual luminophore; the
detector module is operable to compare the phase response outputs with one another to provide information on two or more analytes.

2. The system of claim 1 wherein the individual luminophore is configured for extracting temperature and oxygen concentration.

3-9. (canceled)

10. The system of claim 1 wherein the luminophore is provided in a supporting matrix.

11. The system of claim 10 wherein the supporting matrix has a permeability biased for the sensing application of the sensor.

12. The system of claim 11 wherein the supporting matrix is hydrophobic.

13. The system of claim 10 wherein the supporting matrix is pH selective.

14. The system of claim 1 wherein the single-element sensor includes two luminophores, at least one of the two being provided in an encapsulate to engineer a different response characteristic.

15. The system of claim 1 wherein the single-element sensor includes multiple luminophores, individual ones of the multiple luminophores being responsive to specific analytes.

16. The system of claim 15 wherein individual ones of the multiple luminophores are selectively responsive to specific analytes.

17. (canceled)

18. The system of claim 1 further comprising a control module, the detector module being part of the control module and wherein operably the control module provides a driving signal to the excitation source.

19. The system of claim 1 wherein the detector module is operably configured to cross reference the plurality of phase response outputs with one another to provide identification of selected analytes.

20. An oxygen sensor including a system as claimed in claim 1.

21. A method of detecting one or more analytes, the method comprising:
providing an excitation light source having a modulated multi-frequency output;
providing a single-element sensor which includes an individual luminophore for extracting multianalyte information; the individual luminophore sensor being responsive to excitation by the excitation light source to generate a plurality of phase response outputs corresponding with the modulated output of the excitation source, and
analysing the plurality of phase response outputs to provide information on the presence of the one or more analytes;
determining quantitative information on the one or more analytes from emitted luminescence; the determination provides simultaneous quantitative information on two or more analytes

22-24. (canceled)

25. The method of claim 21 wherein the single-element sensor provides a luminescence response to excitation, the method including determining quantitative information from said emitted luminescence on the one or more analytes.

26-28. (canceled)

29. The method of claim 21 wherein the single-element sensor is a single fluorescent sensor element doped with a single luminophore.

30. (canceled)

31. The method of claim 21 wherein the method further comprises the step of simultaneously detecting at least two analytes selected from the group consisting of O₂, humidity, pH, CO₂, chlorine, ammonia, volatile amines, nitrates, calcium, and metal ions or any subset thereof.

32. The method of claim 31 wherein said single-element sensor is a single phase fluorometric oxygen sensor.

33. (canceled)

34. The method of claim 31 wherein the detection is effected using a single fluorescent sensor element, doped with a single luminophore.

35. A sensor system for detecting the presence of one or more analytes comprising:
an excitation source,
a sensor element,
wherein the sensor element is responsive to excitation by the excitation source to generate a plurality of phase response outputs providing information on the presence of the one or more ambient analytes.
